(19) United States
(12) Patent Application Publication
(10) Pub. No.: US 2023/0169776 A1
(43) Pub. Date: Jun. 1, 2023

(54) DRIVER ASSISTANCE APPARATUS, A VEHICLE, AND A METHOD OF CONTROLLING THE SAME

(71) Applicants: HYUNDAI MOTOR COMPANY, Seoul (KR); KIA CORPORATION, Seoul (KR)

(72) Inventor: Won Taek Oh, Suwon-si (KR)

(73) Assignees: HYUNDAI MOTOR COMPANY, Seoul (KR); KIA CORPORATION, Seoul (KR)

(21) Appl. No.: 18/072,393

(22) Filed: Nov. 30, 2022

(30) Foreign Application Priority Data
Dec. 1, 2021 (KR) 10-2021-0169986

(51) Int. Cl. G06V 20/56; G06V 10/56; G06T 5/00

(52) U.S. Cl. CPC G06V 20/56; G06V 10/56; G06T 5/007; G06T 2207/30252

(57) ABSTRACT

A vehicle is disclosed that includes a display, a camera having a field of view including a part of the vehicle and configured to obtain an image outside the vehicle, and a controller configured to process the image. The controller is configured to identify a region representing the part of the vehicle in the image, correct at least one of luminance or color of the identified region, and display a corrected image including the corrected region on the display.

### CROSS-REFERENCE TO RELATED APPLICATION(S)

This application claims the benefit of Korean Patent Application No. 10-2021-0169986, filed on Dec. 1, 2021, the entire contents of which are incorporated herein by reference.

### TECHNICAL FIELD

The present disclosure relates to a driver assistance apparatus, a vehicle, and a method of controlling the same, and more particularly, to a driver assistance apparatus assisting a driver's control of a vehicle, a vehicle, and a method of controlling the same.

### BACKGROUND

In general, vehicles are the most common means of transportation in modern society, and people using vehicles are also increasing. The development of vehicle technologies has advantages such as making it easier to travel long-distance and making life easier. However, in places with high population density such as Korea, the development of vehicle technologies causes serious traffic congestion, thereby deteriorating road traffic conditions.

Recently, to reduce a burden on a driver and increase convenience, a study for a vehicle equipped with an Advanced Driver Assist System (ADAS) that dynamically provides information on a vehicle condition, a driver condition, and a surrounding environment has been actively ongoing.

For example, ADAS mounted on vehicles includes a Forward Collision Avoidance (FCA), an Autonomous Emergency Brake (AEB), and a Driver Attention Warning (DAW), and the like.

A driver assistance apparatus may assist with driving a vehicle as well as assist parking the vehicle.

### SUMMARY

An aspect of the disclosure is to provide a driver assistance apparatus capable of displaying an image for parking corrected to clearly distinguish a captured vehicle body from a parking space, and a vehicle and a method of controlling the same.

Additional aspects of the disclosure are set forth in part in the description which follows and, in part, should be understood from the description, or may be learned by practice of the disclosure.

In accordance with an aspect of the disclosure, a vehicle includes a display, a camera having a field of view including a part of the vehicle and configured to obtain an image outside the vehicle, and a controller configured to process the image. The controller is configured to identify a region representing the part of the vehicle in the image, correct at least one of luminance or color of the identified region, and display a corrected image including the corrected region on the display.

The controller may be further configured to correct at least one of the luminance and color of the identified region based on an image deviation between an inside of the identified region and an outside of the identified region.

The controller may be further configured to correct the luminance of the identified region to increase a difference between the luminance inside the identified region and a luminance outside the identified region based on the difference between the luminance inside the identified region and the luminance outside the identified region being less than or equal to a first luminance reference value.

The controller may be further configured to correct the color of the identified region to increase a difference between the color inside the identified region and a color outside the identified region based on the difference between the color inside the identified region and the color outside the identified region being less than or equal to a first color reference value.

The controller may be further configured to correct at least one of the luminance and color of the identified region based on an image deviation between a plurality of reference points inside the identified region.

The controller may be further configured to correct the luminance of the identified region to flatten the luminance inside the identified region based on a luminance deviation between a plurality of reference points inside the identified region being greater than or equal to a second luminance reference value.

The controller may be further configured to correct the color of the identified region to flatten the color inside the identified region based on a color deviation between a plurality of reference points inside the identified region being greater than or equal to a second color reference value.

In accordance with another aspect of the disclosure, a method of controlling a vehicle including a camera having a field of view that includes a part of the vehicle includes obtaining an image outside the vehicle, identifying a region representing the part of the vehicle in the image, correcting at least one of luminance or color of the identified region, and displaying a corrected image including the corrected region.

The correcting at least one of the luminance and color of the identified region may further include correcting at least one of the luminance and color of the identified region based on an image deviation between an inside of the identified region and an outside of the identified region.

The correcting at least one of the luminance and color of the identified region may further include correcting the luminance of the identified region to increase a difference between the luminance inside the identified region and a luminance outside the identified region based on the difference between the luminance inside the identified region and the luminance outside the identified region being less than or equal to a first luminance reference value.

The correcting at least one of the luminance and color of the identified region may further include correcting the color of the identified region to increase a difference between the color inside the identified region and a color outside the identified region based on the difference between the color inside the identified region and the color outside the identified region being less than or equal to a first color reference value.

The correcting at least one of the luminance and color of the identified region may further include correcting at least one of the luminance and color of the identified region based on an image deviation between a plurality of reference points inside the identified region.

The correcting at least one of the luminance and color of the identified region may further include correcting the luminance of the identified region to flatten the luminance inside the identified region based on a luminance deviation between a plurality of reference points inside the identified region being greater than or equal to a second luminance reference value.

The correcting at least one of the luminance and color of the identified region may further include correcting the color of the identified region to flatten the color inside the identified region based on a color deviation between a plurality of reference points inside the identified region being greater than or equal to a second color reference value.

In accordance with another aspect of the disclosure, a driver assistance apparatus includes a camera having a field of view including a part of a vehicle and obtaining an image outside the vehicle and a controller configured to process the image. The controller is further configured to identify a region representing the part of the vehicle in the image, correct at least one of luminance or color of the identified region, and display a corrected image including the corrected region on a display of the vehicle.

The controller may be further configured to correct at least one of the luminance and color of the identified region based on an image deviation between an inside of the identified region and an outside of the identified region.

The controller may be further configured to correct the luminance of the identified region to increase a difference between the luminance inside the identified region and a luminance outside the identified region based on the difference between the luminance inside the identified region and the luminance outside the identified region being less than or equal to a first luminance reference value.

The controller may be further configured to correct the color of the identified region to increase a difference between the color inside the identified region and a color outside the identified region based on the difference between the color inside the identified region and the color outside the identified region being less than or equal to a first color reference value.

The controller may be further configured to correct at least one of the luminance and color of the identified region based on an image deviation between a plurality of reference points inside the identified region.

The controller may be further configured to correct the luminance of the identified region to flatten the luminance inside the identified region based on a luminance deviation between a plurality of reference points inside the identified region being greater than or equal to a second luminance reference value.

The controller may be further configured to correct the color of the identified region to flatten the color inside the identified region based on a color deviation between a plurality of reference points inside the identified region being greater than or equal to a second color reference value.

### BRIEF DESCRIPTION OF THE DRAWINGS

These and/or other aspects of the disclosure should be apparent and more readily appreciated from the following description of the embodiments, taken in conjunction with the accompanying drawings of which:

FIG. 1 shows a configuration of a vehicle according to an embodiment of the disclosure;

FIG. 2 shows a field of view of cameras installed in a vehicle according to an embodiment of the disclosure;

FIG. 3 shows image data captured by cameras included in a driver assistance apparatus according to an embodiment of the disclosure;

FIG. 4 shows a region of interest in an image captured by cameras included in a driver assistance apparatus according to an embodiment of the disclosure;

FIG. 5 shows an example of comparing inside and outside a region of interest (ROI) of images captured by cameras included in the driver assistance apparatus according to an embodiment of the disclosure;

FIG. 6 shows an example of comparing images inside the ROI of images captured by cameras included in a driver assistance apparatus according to an embodiment of the disclosure;

FIG. 7 shows the ROI and captured image corrected by a driver assistance apparatus according to an embodiment of the disclosure;

FIG. 8 shows an image in which the ROI corrected by a driver assistance apparatus according to an embodiment of the disclosure is superimposed; and

FIG. 9 shows a method of controlling a driver assistance apparatus according to an embodiment of the disclosure.

### DETAILED DESCRIPTION

Reference is made below in detail to the embodiments of the disclosure, examples of which are illustrated in the accompanying drawings, wherein like reference numerals refer to like elements throughout. This specification does not describe all elements of the disclosed embodiments and detailed descriptions of what is well known in the art or redundant descriptions on substantially the same configurations have been omitted. The terms ‘part’, ‘module’, ‘member’, ‘block’ and the like as used in the specification may be implemented in software or hardware. Further, a plurality of ‘part’, ‘module’, ‘member’, ‘block’ and the like may be embodied as one component. It is also possible that one ‘part’, ‘module’, ‘member’, ‘block’ and the like includes a plurality of components.

Throughout the specification, when an element is referred to as being “connected to” another element, it may be directly or indirectly connected to the other element and the “indirectly connected to” includes being connected to the other element via a wireless communication network.

Also, it is to be understood that the terms “include” and “have” are intended to indicate the existence of elements disclosed in the specification, and are not intended to preclude the possibility that one or more other elements may exist or may be added.

Throughout the specification, when a member is located “on” another member, this includes not only when one member is in contact with another member but also when another member is present between the two members.

The terms first, second, and the like are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

When a component, device, element, or the like of the present disclosure is described as having a purpose or performing an operation, function, or the like, the component, device, or element should be considered herein as being “configured to” meet that purpose or to perform that operation or function.

Hereinafter, embodiments of the disclosure are described in detail with reference to the accompanying drawings.

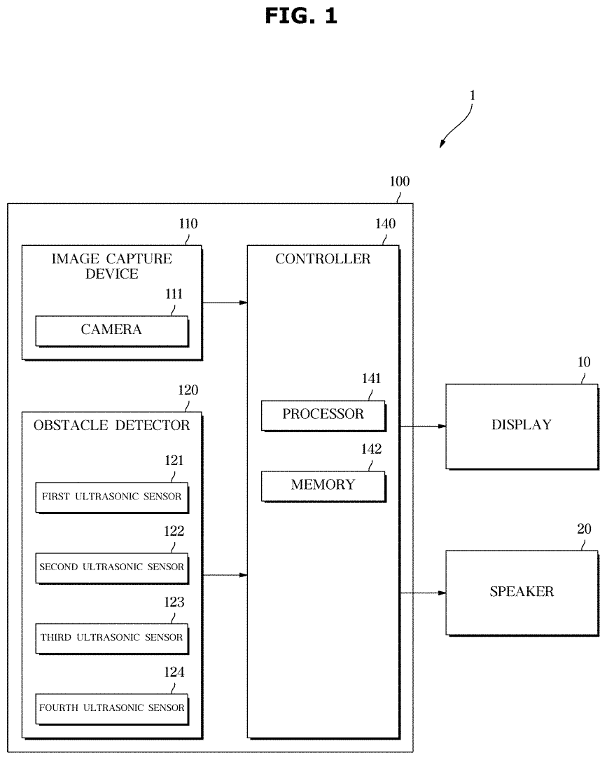

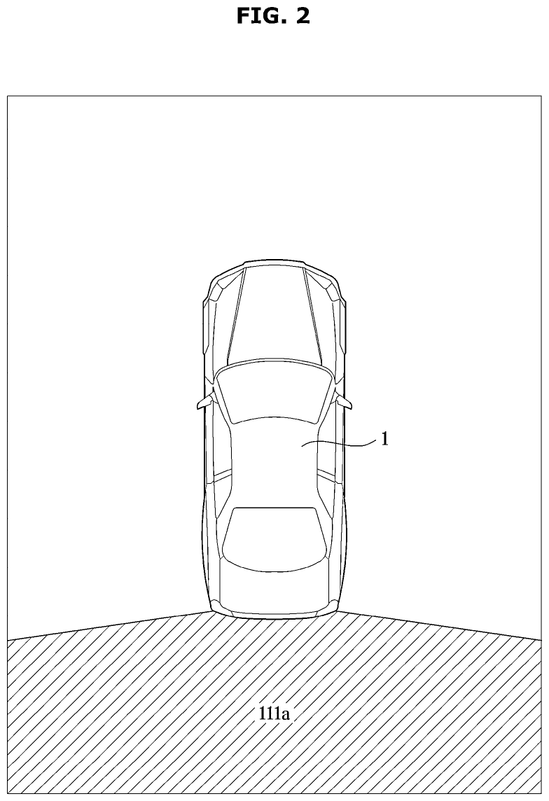

FIG. 1 shows a configuration of a vehicle according to an embodiment of the disclosure. FIG. 2 shows a field of view of cameras installed in a vehicle according to an embodiment of the disclosure.

As shown in FIG. 1, a vehicle 1 includes a display 10 for displaying motion information, a speaker 20 for outputting motion sound, and a driver assistance apparatus 100 for assisting a driver.

The display 10 may receive image data from the driver assistance apparatus 100 and may display an image corresponding to the received image data. The display 10 may include a cluster and a multimedia player.

The cluster may be provided in front of a driver and may display driving information of the vehicle 1 including a driving speed of the vehicle 1, RPM of an engine, and/or an amount of fuel, and the like. Furthermore, the cluster may display an image provided from the driver assistance apparatus 100.

The multimedia player may display an image (or a video) for convenience and fun of a driver. Furthermore, the multimedia player may display an image provided from the driver assistance apparatus 100.

The speaker 20 may receive sound data from the driver assistance apparatus 100 and may output a sound corresponding to the received sound data.

The driver assistance apparatus 100 includes an image capture device 110 that captures an image around the vehicle 1 and obtains image data, an obstacle detector 120 that detects obstacles around the vehicle 1 without contact, and a controller 140 that controls an operation of the driver assistance apparatus 100 based on an output of the image capture device 110 and an output of the obstacle detector 120. Herein, an obstacle is an object that obstructs the driving of the vehicle 1, and may include, for example, a vehicle, a pedestrian, a structure on a road, and the like.

The image capture device 110 includes a camera 111.

The camera 111 may photograph a rear of the vehicle 1 and obtain image data of the rear of the vehicle 1.

The camera 111 may have a first field of view (FOV) 111a facing the rear of the vehicle 1 as shown in FIG. 2. For example, the camera 111 may be installed on a tailgate of the vehicle 1.

The camera 111 may include a plurality of lenses and image sensors. The image sensors may include a plurality of photodiodes that convert light into an electrical signal, and the plurality of photodiodes may be arranged in a two-dimensional matrix.

The camera 111 may be electrically connected to the controller 140. For example, the camera 111 may be connected to the controller 140 through a communication network (NT) for a vehicle, or connected to the controller 140 through a hard wire, or connected to the controller 140 through a signal line of a printed circuit board (PCB).

The camera 111 may provide image data of a front of the vehicle 1 to the controller 140.

The obstacle detector 120 includes a first ultrasonic sensor 121, a second ultrasonic sensor 122, a third ultrasonic sensor 123, and a fourth ultrasonic sensor 124.

The first ultrasonic sensor 121 may detect an obstacle positioned in front of the vehicle 1, and may output first detection data indicating whether the obstacle is detected and a position of the obstacle. The first ultrasonic sensor 121 may include a transmitter that transmits ultrasonic waves toward in front of the vehicle 1 and a receiver that receives ultrasonic waves reflected from the obstacle positioned in front of the vehicle 1. For example, the first ultrasonic sensor 121 may include a plurality of transmitters provided in front of the vehicle 1 or a plurality of receivers provided in front of the vehicle 1 in order to identify the position of the obstacle in front of the vehicle 1.

The first ultrasonic sensor 121 may be electrically connected to the controller 140. For example, the camera 111 may be connected to the controller 140 through the NT, or connected to the controller 140 through the hard wires, or connected to the controller 140 through signal lines of the PCB.

The first ultrasonic sensor 121 may provide first detection data of the front of the vehicle 1 to the controller 140.

The second ultrasonic sensor 122 may detect an obstacle at a rear of the vehicle 1 and may output second detection data of the rear of the vehicle 1. For example, the second ultrasonic sensor 122 may include a plurality of transmitters provided at the rear of the vehicle 1 or a plurality of receivers provided at the rear of the vehicle 1 in order to identify the position of the obstacle at the rear of the vehicle 1.

The second ultrasonic sensor 122 may be electrically connected to the controller 140, and may provide second detection data of the rear of the vehicle 1 to the controller 140.

The third ultrasonic sensor 123 may detect an obstacle on a left side of the vehicle 1 and output third detection data on the left side of the vehicle 1. For example, the third ultrasonic sensor 123 may include a plurality of transmitters provided on the left side of the vehicle 1 or a plurality of receivers provided on the left side of the vehicle 1 in order to identify the position of the obstacle on the left side of the vehicle 1.

The third ultrasonic sensor 123 may be electrically connected to the controller 140, and may provide third detection data on the left side of the vehicle 1 to the controller 140.

The fourth ultrasonic sensor 124 may detect an obstacle on a right side of the vehicle 1 and output fourth detection data on the right side of the vehicle 1. For example, the fourth ultrasonic sensor 124 may include a plurality of transmitters provided on the right side of the vehicle 1 or a plurality of receivers provided on the right side of the vehicle 1 in order to identify the position of the obstacle on the right side of the vehicle 1.

The fourth ultrasonic sensor 124 may be electrically connected to the controller 140, and may provide fourth detection data of the right side of the vehicle 1 to the controller 140.

The controller 140 may be electrically connected to the camera 111 included in the image capture device 110 and the plurality of ultrasonic sensors 121, 122, 123, and 124 included in the obstacle detector 120. Furthermore, the controller 140 may be connected to the display 10 of the vehicle 1 through the NT, or the like.

The controller 140 includes a processor 141 and a memory 142. The controller 140 may include, for example, one or more processors or one or more memories. The processor 141 and the memory 142 may be implemented as separate semiconductor devices or as one single semiconductor device.

The processor 141 may include one chip (or a core) or a plurality of chips (or cores). For example, the processor 141 may be a digital signal processor (DSP) that processes detection data of first and second radars, and/or a micro control unit (MCU) that generates a driving signal/braking signal/steering signal.

The processor 141 may receive a plurality of detection data from the plurality of ultrasonic sensors 121, 122, 123, and 124, identify whether an obstacle is positioned in a vicinity of the vehicle 1 based on the received detection data, and identify the position of obstacles. For example, the processor 141 may identify whether the obstacle is located in front or rear or on the left side or the right side of the vehicle 1. Furthermore, the processor 141 may identify an obstacle located in a front left side of the vehicle 1, an obstacle located in a front right side of the vehicle 1, an obstacle located in a rear left side of the vehicle 1, and an obstacle located in a rear right side of the vehicle 1.

The processor 141 may output a warning sound to the speaker 20 in response to a distance and/or direction to the identified obstacle. The driver assistance apparatus 100 may provide sound data corresponding to the warning sound to the speaker 20.

The processor 141 may receive image data from the camera 111 and correct the received image data. For example, the processor 141 may correct the image data so that the vehicle 1 and surrounding environments (e.g., a parking space) may be clearly distinguished, and may output the corrected image data. The driver assistance apparatus 100 may provide the corrected image data to the display 10. The display 10 may display an image corresponding to the corrected image data.

The memory 142 may process the detection data of the ultrasonic sensors 121, 122, 123, and 124 and the image data of the camera 111, and store or temporarily store programs and data for controlling the operation of the driver assistance apparatus 100.

The memory 142 may include not only volatile memories such as a static random access memory (S-RAM) and a dynamic random-access memory (D-RAM), but also non-volatile memory such as a flash memory, a read-only memory (ROM), an erasable programmable read only memory (EPROM), and the like. The memory 142 may include one memory element or a plurality of memory elements.

As described above, the controller 140 may identify the obstacles around the vehicle 1, and output the images around the vehicle 1 for parking, by programs and data stored in the memory 142 and the operation of the processor 141.

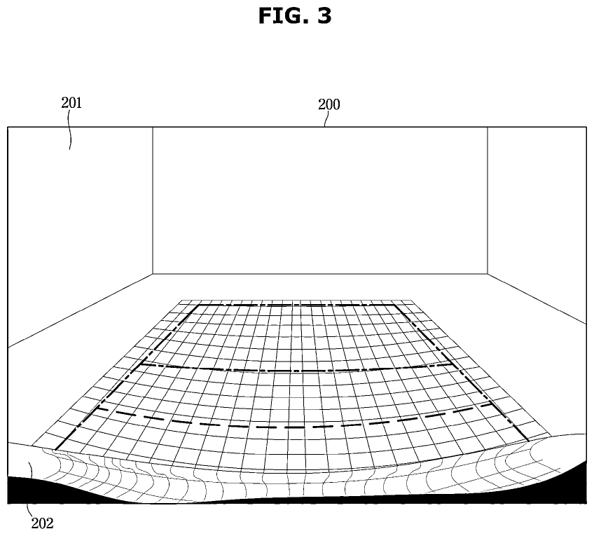

FIG. 3 shows image data captured by the camera 111 included in a driver assistance apparatus according to an embodiment of the disclosure.

The camera 111 may capture images (for example, a rear image of the vehicle) around the vehicle 1 (hereinafter, referred to as a photographed image), and output image data corresponding to a captured image 200.

The captured image 200 may include an image representing the objects located in the vicinity of the vehicle 1 and an image representing a part of the vehicle 1. As shown in FIG. 3, the captured image 200 may include a surrounding image area 201 representing an image of a surrounding region of the vehicle 1, and a vehicle body image area 202 representing a part (e.g., a vehicle body) of the vehicle 1.

Because the captured image 200 includes the vehicle body image area 202, a driver easily may recognize or predict a distance between the vehicle 1 and the obstacle during low-speed driving for parking (including reverse driving and/or advance driving). In other words, the driver may identify both the part of the vehicle 1 and the obstacle, which are included in the image displayed on the display 10, and estimate the distance between the part of the vehicle 1 and the obstacle through the image including the part of the vehicle 1 and the obstacles.

Because the captured image 200 includes the vehicle body image area 202, the vehicle 1 may provide the driver with confidence regarding the distance between the vehicle 1 and the obstacle. For example, when the captured image 200 includes a virtual image representing the vehicle 1, it is difficult for the driver to estimate the distance between the vehicle 1 and the obstacle, and not to trust the distance therebetween.

The captured image 200 may be variously changed depending on an illumination outside the vehicle 1 or an external lighting of the vehicle 1.

For example, when an intensity of external lighting is strong (e.g., during the day), light reflection may occur in a part of the vehicle 1 included in the captured image 200. In other words, an image of the object positioned around the vehicle 1 may be reflected from the vehicle 1 and captured by the camera 111. Accordingly, a reflection image of the objects around the vehicle 1 may appear in the vehicle body image area 202 of the captured image 200. As the reflection image of the objects around the vehicle 1 appear in the vehicle body image area 202, it may be difficult for the driver to distinguish a portion for the vehicle 1 from a portion of the surroundings of the vehicle 1 in the captured image 200.

As another example, when the intensity of external lighting is weak (e.g., at night or inside a tunnel), the captured image 200 may be entirely dark. In other words, brightness of both the vehicle body image area 202 and the surrounding image area 201 included in the captured image 200 may be lowered. Accordingly, it may be difficult for the driver to distinguish the vehicle body image area 202 from the surrounding image area 201.

As such, when the captured image 200 is displayed on the display 10 as it is, it is difficult for the driver to estimate the distance between the vehicle 1 and the obstacle depending on the illumination around the vehicle 1 or the lighting around the vehicle 1. Accordingly, it may become difficult for the driver to safely park the vehicle 1 in a parking space.

To prevent this, the vehicle 1 may correct the image 200 captured by the camera 111.

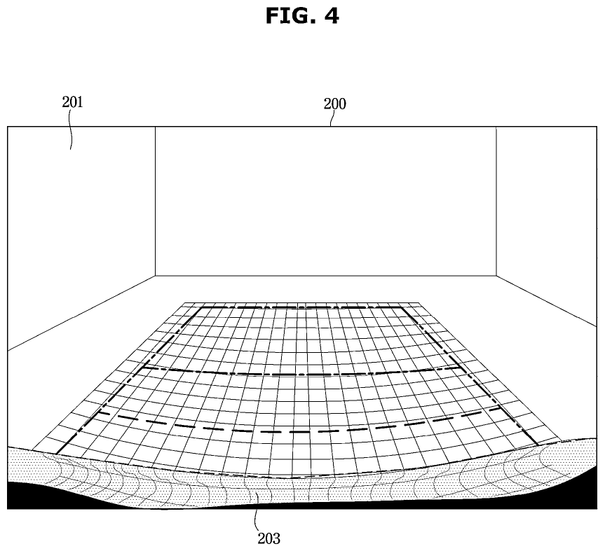

FIG. 4 shows a region of interest (ROI) in an image captured by a camera 111 included in a driver assistance apparatus according to an embodiment of the disclosure

The camera 111 of the driver assistance apparatus 100 captures a surrounding of the vehicle 1 including a part of the vehicle 1, and obtains the captured image 200 around the vehicle 1 including a part of the vehicle 1. The camera 111 may provide the captured image 200 to the controller 140.

The controller 140 may receive the captured image 200 and set a ROI 203 in the captured image 200. Herein, the ROI 203 may be the same as the vehicle body image area 202, which is described in FIG. 3.

For example, the ROI 203 may be determined in advance. Based on an installation position and/or the FOV of the camera 111, a region in which a part of the vehicle 1 is captured may be distinguished from the image captured by the camera 111. The region in which a part of the vehicle 1 is captured may be set as the ROI.

As another example, the ROI 203 may be set based on image processing of the captured image 200. In the region in which a part of the vehicle 1 is captured, a change in color and/or brightness may be small compared to a region in which the surrounding of the vehicle 1 is captured. The controller 140 may extract edges of the captured image 200 using edge extraction algorithms, and may divide the captured image into a plurality of regions based on the extracted edges. The controller 140 may identify the change in color and/or brightness over time for each region, and may set the ROI 203 based on the change in color and/or brightness.

As such, the controller 140 may identify the ROI 203 indicating a part of the vehicle 1 in the captured image 200.

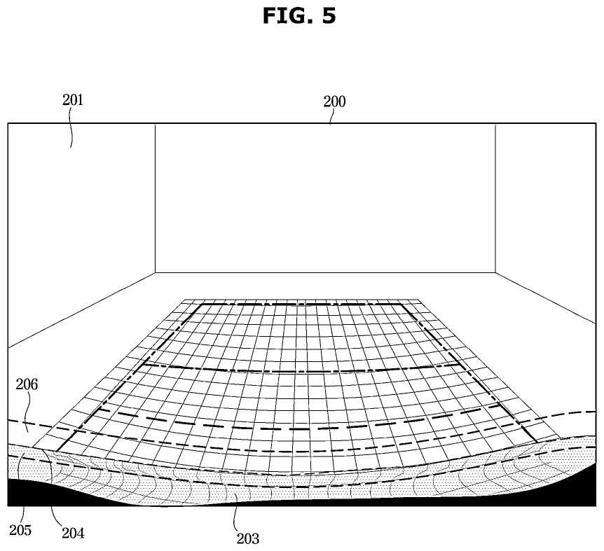

FIG. 5 shows an example of comparing inside and outside the ROI of the image captured by the camera 111 included in the driver assistance apparatus according to an embodiment of the disclosure.

The controller 140 may identify the ROI 203 representing a part of the vehicle 1 in the captured image 200.

The controller 140 may identify a boundary line 204 between the ROI 203 and other regions in the captured image 200. Furthermore, the controller 140 may identify an inner region 205 of the ROI 203 adjacent to the boundary line 204 and an outer region 206 of the ROI 203 adjacent to the boundary line 204, based on the boundary line 204. For example, the controller 140 may identify the inner region 205 having a predetermined distance (a predetermined number of pixels) from the boundary line 204 toward the inside of the ROI 203, and the outer region 206 having a predetermined distance (a predetermined number of pixels) from the boundary line 204 toward the outside of the region 203.

The controller 140 may identify that a contrast ratio between the ROI 203 and the other regions is lowered based on a comparison between the brightness of the inner region 205 and the brightness of the outer region 206.

For example, the controller 140 may identify a first luminance deviation representing a difference between an average luminance value of the outer region 206 and an average luminance value of the inner region 205, and compare the first luminance deviation with a first luminance reference value. In response to the first luminance deviation being smaller than the first luminance reference value, the controller 140 may identify that the contrast ratio between the ROI 203 and the other regions is lowered.

Furthermore, the controller 140 may identify that the contrast ratio between the ROI 203 and the other regions is lowered based on a color deviation between the inner region 205 and the outer region 206.

For example, the controller 140 may identify a first red deviation representing a difference between an R value indicating red of the outer region 206 and an R value indicating red of the inner region 205, and compare the first red deviation with a red reference value. Herein, the R value of the outer region 206 and the R value of the inner region 205 may refer to, for example, an average value of the R values of the outer region 206 and an average value of the R values of the inner region 205.

The controller 140 may identify a first green deviation representing a difference between a G value indicating green of the outer region 206 and a G value indicating green of the inner region 205, and compare the first green deviation with a green reference value. Herein, the G value of the outer region 206 and the G value of the inner region 205 may refer to, for example, an average value of the G values in the outer region 206 and an average value of the G values in the inner region 205.

The controller 140 may identify a first blue deviation representing a difference between a B value indicating blue of the outer region 206 and a B value indicating blue of the inner region 205, and compare the first blue deviation with a blue reference value. Herein, the B value of the outer region 206 and the B value of the inner region 205 may refer to, for example, an average value of the B values in the outer region 206 and an average value of the B values in the inner region 205.

In response to the first red deviation being less than or equal to the first red reference value, the first green deviation being less than or equal to the first green reference value, and the first blue deviation being less than or equal to the first blue reference value, the controller 140 may identify that the contrast ratio between the ROI 203 and other regions is lowered. In other words, when the first color deviation is less than or equal to the reference value, the controller 140 may identify that the contrast ratio between the ROI 203 and other regions is lowered.

Upon identifying that the contrast ratio between the ROI 203 and other regions is lowered, the controller 140 may correct the ROI 203 to improve the contrast ratio between the ROI 203 and other regions using a contrast improvement algorithm. For example, the controller 140 may correct the luminance and/or color within the ROI 203 to increase the luminance and/or color difference between the ROI 203 and other regions.

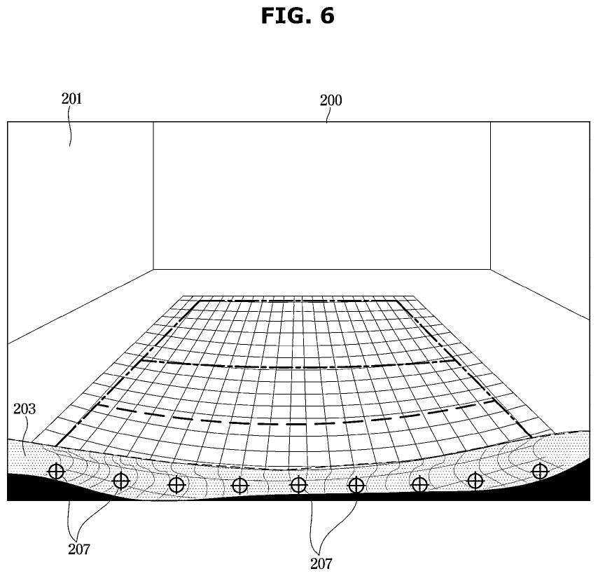

FIG. 6 shows an example of comparing images inside an ROI of images captured by the camera 111 included in a driver assistance apparatus according to an embodiment of the disclosure.

The controller 140 may identify the ROI 203 representing a part of the vehicle 1 in the captured image 200.

The controller 140 may identify interference such as reflection or saturation within the ROI 203 based on a change in brightness within the ROI 203.

The controller 140 may identify a plurality of reference points 207 in the ROI 203. For example, the controller 140 may identify predetermined coordinates in the ROI 203 as the plurality of reference points 207, or may randomly select the plurality of reference points 207 in the ROI 203.

The controller 140 may identify interference such as reflection or saturation within the ROI 203 based on a second luminance deviation representing a change in brightness at the plurality of identified reference points 207.

For example, the controller 140 may calculate an average value of brightness from the plurality of identified reference points 207, and calculate the square of a difference between the average value of brightness and the luminance value of each of the plurality of reference points 207. The controller 140 may calculate the second luminance deviation from the plurality of reference points 207 by summing the squares.

In response to the second luminance deviation being greater than a second luminance reference value, the controller 140 may identify interference such as reflection or saturation within the ROI 203.

Furthermore, the controller 140 may identify interference such as reflection or saturation within the ROI 203 based on the color deviation within the ROI 203.

For example, the controller 140 may calculate the average value of the R values indicating red from the plurality of identified reference points 207, and calculate the square of the difference between the average value of the R values and the R value of each of the plurality of reference points 207. The controller 140 may calculate a second red deviation from the plurality of reference points 207 by summing the squares.

The controller 140 may calculate the average value of the G values indicating green from the plurality of identified reference points 207, and calculate the square of the difference between the average value of the G values and the G value of each of the plurality of reference points 207. The controller 140 may calculate a second green deviation from the plurality of reference points 207 by summing the squares.

The controller 140 may calculate the average value of the B values indicating blue from the plurality of identified reference points 207, and calculate the square of the difference between the average value of the B values and the B value of each of the plurality of reference points 207. The controller 140 may calculate a second blue deviation from the plurality of reference points 207 by summing the squares.

In response to the second red deviation being greater than or equal to a second red reference value, the second green deviation being greater than or equal to a second green reference value, or the second blue deviation being greater than or equal to a second blue reference value, the controller 140 may identify interference such as reflection or saturation within the ROI 203.

Upon identifying interference such as reflection or saturation within the ROI 203, the controller 140 may correct the ROI 203 to attenuate reflection and/or saturation within the ROI 203 using a reflection/saturation attenuation algorithm. For example, the controller 140 may flatten the luminance and/or color within the ROI 203.

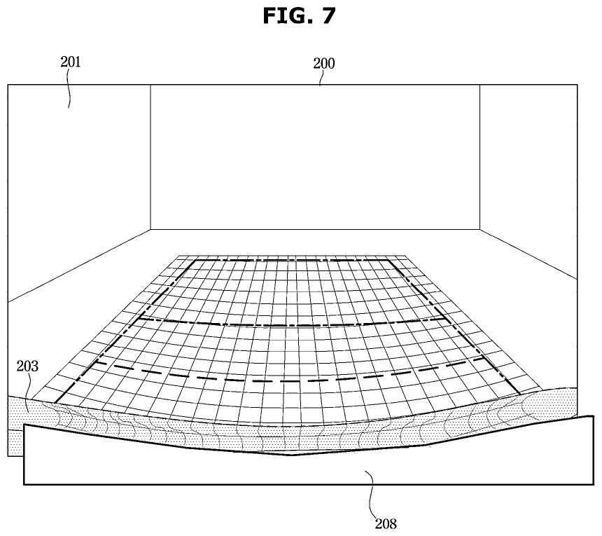

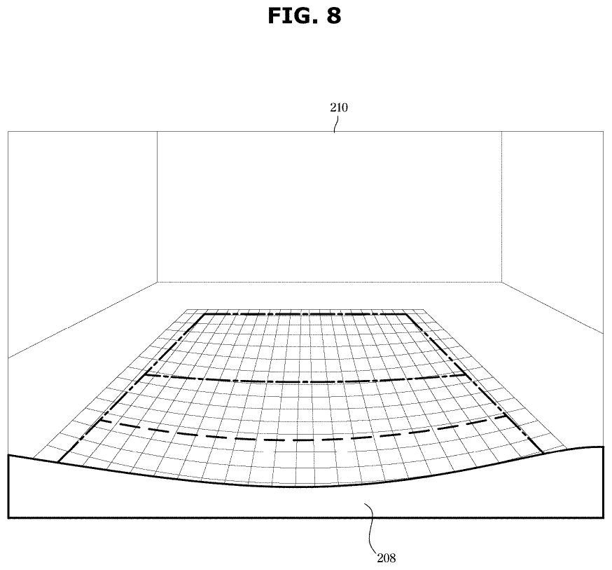

FIG. 7 shows the ROI and captured image corrected by a driver assistance apparatus according to an embodiment of the disclosure. FIG. 8 shows an image in which the ROI corrected by a driver assistance apparatus according to an embodiment of the disclosure is superimposed.

As shown in FIG. 7, the controller 140 may output a corrected ROI 208 by correcting the ROI 203. For example, the controller 140 may output the corrected ROI 208 by flattening the luminance and/or color within the ROI 203 or correcting the luminance and/or color within the ROI 203.

As shown in FIG. 8, the controller 140 may superimpose the corrected ROI 208 on the captured image 200. Accordingly, the controller 140 may output a corrected image 210 including the corrected ROI 208.

The controller 140 may provide image data including the corrected ROI 208 to the display 10. The display 10 may display the corrected image 210 including the corrected ROI 208.

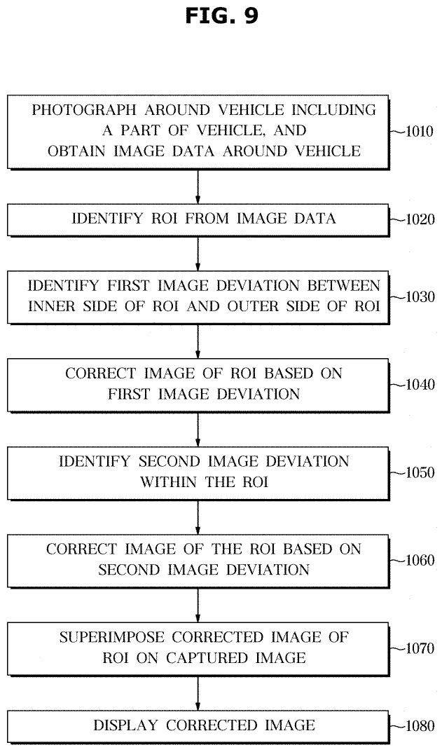

FIG. 9 shows a method of controlling a driver assistance apparatus according to an embodiment of the disclosure.

The driver assistance apparatus 100 may photograph around the vehicle 1 including a part of the vehicle 1 and obtain image data around the vehicle (1010).

For example, the camera 111 may photograph the surroundings of the vehicle 1 including a part of the vehicle 1, obtain image data, and provide the image data to the controller 140. The controller 140 may obtain the image data around the vehicle 1 including a part of the vehicle 1 from the camera 111.

The driver assistance apparatus 100 may identify the ROI from the image data (1020).

For example, the controller 140 may identify an image area representing a part of the vehicle 1 in the image data.

The driver assistance apparatus 100 may identify a first image deviation between the inner side of the ROI and the outer side of the ROI (1030).

For example, the controller 140 may identify the first luminance deviation indicating the difference between the luminance inside the ROI and the luminance outside the ROI. The controller 140 may identify the first color deviation indicating the difference between the inner color and outer color of the ROI.

The driver assistance apparatus 100 may correct the image of the ROI based on the first image deviation (1040).

For example, in response to the first luminance deviation being less than or equal to the first luminance reference value or the first color deviation being less than or equal to the first color reference value, the controller 140 may correct the luminance and/or color of the ROI.

The driver assistance apparatus 100 may identify a second image deviation within the ROI (1050).

For example, the controller 140 may identify the second luminance deviation at the plurality of positions within the ROI. The controller 140 may identify the second color deviation at the plurality of positions within the ROI.

The driver assistance apparatus 100 may correct the image of the ROI based on the second image deviation (1060).

For example, in response to the second luminance deviation being greater than or equal to the second luminance reference value or the second color deviation being greater than or equal to the second color reference value, the controller 140 may correct the luminance and/or color of the ROI.

The driver assistance apparatus 100 may superimpose the corrected image of the ROI on the captured image (1070).

For example, the controller 140 may output the corrected image by superimposing the corrected image of the ROI on the captured image.

The driver assistance apparatus 100 may display the corrected image (1080).

For example, the controller 140 may output the corrected image to the display 10. The display 10 may display the corrected image.

As is apparent from the above, various embodiments of the present disclosure may provide the driver assistance apparatus capable of displaying a corrected image for parking to clearly distinguish the captured vehicle body from a parking space, a vehicle, and a method of controlling the same. As a result, the driver's misrecognition of the parking space may be suppressed or prevented.

On the other hand, the above-described embodiments may be implemented in the form of a recording medium storing instructions executable by a computer. The instructions may be stored in the form of program code. When the instructions are executed by a processor, a program module is generated by the instructions so that the operations of the disclosed embodiments may be carried out. The recording medium may be implemented as a computer-readable recording medium.

The computer-readable recording medium includes all types of recording media storing data readable by a computer system. Examples of the computer-readable recording medium include a Read Only Memory (ROM), a Random Access Memory (RAM), a magnetic tape, a magnetic disk, a flash memory, an optical data storage device, or the like.

Although embodiments of the disclosure have been shown and described, it should be appreciated by those having ordinary skill in the art that changes may be made in these embodiments without departing from the principles and spirit of the disclosure, the scope of which is defined in the claims and their equivalents.

What is claimed is:

1. A vehicle, comprising:
a display;
a camera having a field of view including a part of the vehicle and configured to obtain an image outside the vehicle; and
a controller configured to process the image;
wherein the controller is configured to:
identify a region representing the part of the vehicle in the image;
correct at least one of luminance or color of the identified region; and
display a corrected image including the corrected region on the display.

2. The vehicle of claim 1, wherein the controller is further configured to:
correct at least one of the luminance and color of the identified region based on an image deviation between an inside of the identified region and an outside of the identified region.

3. The vehicle of claim 1, wherein the controller is further configured to:
correct the luminance of the identified region to increase a difference between the luminance inside the identified region and a luminance outside the identified region based on the difference between the luminance inside the identified region and the luminance outside the identified region being less than or equal to a first luminance reference value.

4. The vehicle of claim 1, wherein the controller is further configured to:
correct the color of the identified region to increase a difference between the color inside the identified region and a color outside the identified region based on the difference between the color inside the identified region and the color outside the identified region being less than or equal to a first color reference value.

5. The vehicle of claim 1, wherein the controller is further configured to:
correct at least one of the luminance and color of the identified region based on an image deviation between a plurality of reference points inside the identified region.

6. The vehicle of claim 1, wherein the controller is further configured to:
correct the luminance of the identified region to flatten the luminance inside the identified region based on a luminance deviation between a plurality of reference points inside the identified region being greater than or equal to a second luminance reference value.

7. The vehicle of claim 1, wherein the controller is further configured to:
correct the color of the identified region to flatten the color inside the identified region based on a color deviation between a plurality of reference points inside the identified region being greater than or equal to a second color reference value.

8. A method of controlling a vehicle including a camera having a field of view that includes a part of the vehicle, the method comprising:
obtaining an image outside the vehicle;
identifying a region representing the part of the vehicle in the image;
correcting at least one of luminance or color of the identified region; and
displaying a corrected image including the corrected region.

9. The method of claim 8, wherein correcting at least one of the luminance and color of the identified region further comprises:
correcting at least one of the luminance and color of the identified region based on an image deviation between an inside of the identified region and an outside of the identified region.

10. The method of claim 8, wherein correcting at least one of the luminance and color of the identified region further comprises:
correcting the luminance of the identified region to increase a difference between the luminance inside the identified region and a luminance outside the identified region based on the difference between the luminance inside the identified region and the luminance outside the identified region being less than or equal to a first luminance reference value.

11. The method of claim 8, wherein correcting at least one of the luminance and color of the identified region further comprises:
correcting the color of the identified region to increase a difference between the color inside the identified region and a color outside the identified region based on the difference between the color inside the identified region and the color outside the identified region being less than or equal to a first color reference value.

12. The method of claim 8, wherein correcting at least one of the luminance and color of the identified region further comprises:
correcting at least one of the luminance and color of the identified region based on an image deviation between a plurality of reference points inside the identified region.

13. The method of claim 8, wherein correcting at least one of the luminance and color of the identified region further comprises:
correcting the luminance of the identified region to flatten the luminance inside the identified region based on a luminance deviation between a plurality of reference points inside the identified region being greater than or equal to a second luminance reference value.

14. The method of claim 8, wherein correcting at least one of the luminance and color of the identified region further comprises:
correcting the color of the identified region to flatten the color inside the identified region based on a color deviation between a plurality of reference points inside the identified region being greater than or equal to a second color reference value.

15. A driver assistance apparatus, comprising:
a camera having a field of view including a part of a vehicle and obtaining an image outside the vehicle; and
a controller configured to process the image,
wherein the controller is further configured to:
identify a region representing the part of the vehicle in the image;
correct at least one of luminance or color of the identified region;
display a corrected image including the corrected region on a display of the vehicle.

16. The driver assistance apparatus of claim 15, wherein the controller is further configured to:
correct at least one of the luminance and color of the identified region based on an image deviation between an inside of the identified region and an outside of the identified region.

17. The driver assistance apparatus of claim 15, wherein the controller is further configured to:
correct the luminance of the identified region to increase a difference between the luminance inside the identified region and a luminance outside the identified region based on the difference between the luminance inside the identified region and the luminance outside the identified region being less than or equal to a first luminance reference value.

18. The driver assistance apparatus of claim 15, wherein the controller is further configured to:
correct the color of the identified region to increase a difference between the color inside the identified region and a color outside the identified region based on the difference between the color inside the identified region and the color outside the identified region being less than or equal to a first color reference value.

19. The driver assistance apparatus of claim 15, wherein the controller is further configured to:
correct at least one of the luminance and color of the identified region based on an image deviation between a plurality of reference points inside the identified region.

20. The driver assistance apparatus of claim 15, wherein the controller is further configured to:
correct the luminance of the identified region to flatten the luminance inside the identified region based on a luminance deviation between a plurality of reference points inside the identified region being greater than or equal to a second luminance reference value.

21. The driver assistance apparatus of claim 15, wherein the controller is further configured to:
correct the color of the identified region to flatten the color inside the identified region based on a color deviation between a plurality of reference points inside the identified region being greater than or equal to a second color reference value.
